(19) United States
(12) Patent Application Publication
(10) Pub. No.: US 2012/0244498 A1
(43) Pub. Date: Sep. 27, 2012

(54) FORMABLE RESORBABLE BIOMATERIAL INTERFACE FOR DENTAL IMPLANT DEVICES

(75) Inventor: MALEATA HALL, OCEANSIDE, CA (US)

(73) Assignee: ZIMMER DENTAL, INC., CARLSBAD, CA (US)

(21) Appl. No.: 13/070,177

(22) Filed: Mar. 23, 2011

(51) Int. Cl. A61C 8/00; A61C 13/093

(52) U.S. Cl. 433/173; 433/201.1

(57) ABSTRACT

A method is provided for forming a three-dimensional resorbable product contoured to a bone defect in a mandible or maxilla. The product is also provided. At least one surface of a resorbable biomaterial element is textured to allow the element to be bent and formed into a three-dimensional shape that conforms to the shape of the bone defect. Texturing includes forming a plurality of pores or grooves in the element. Grooves are formed in at least one direction, in at least one surface of the element, and are formed to a depth sufficient to allow the element to be bent at the grooves.

### TECHNICAL FIELD

The disclosure is generally related to the field of bone implants, including dental implants, and, more particularly, to a formable three-dimensional resorbable interface that may be employed with various dental implant devices.

### BACKGROUND

It is becoming more common to replace a missing tooth with a prosthetic tooth that is placed upon and attached to a dental implant. The dental implant serves as the artificial root in that it integrates with the jawbone. Dental implants require bones underneath them for support and to have the implant integrate properly. People who have been edentulous (without teeth) for a prolonged period may not have enough bone left in the necessary locations. Bone grafting may be necessary in cases where there is a lack of adequate maxillary or mandibular bone in terms of front to back depth or thickness, top to bottom height, and left to right width. Sufficient bone is needed in three dimensions to securely integrate with the root-like implant. Improved bone height is particularly important to assure ample anchorage of the implant's root-like shape because it has to support the mechanical stress of chewing, just like a natural tooth. In such cases, bone grafts from the chin, from the pilot holes for the implants or even from the iliac crest of the pelvis have been used.

Bone grafts have various drawbacks including a limited amount of tissue available for grafting, lack of available or appropriate donor sites, and limitations on size and contour to match a defect site. Perforated metal sheets have also been used to correct bone defects prior to dental implantations. A metal mesh, such as titanium mesh, is applied to the bone defect. A disadvantage of the metal mesh is that it is not resorbable and must be removed after bone formation has occurred or a defect has been restored. This adds trauma to the overall procedure. Accordingly, it may be desirable to provide an alternative material that provides increased vascular ingrowth and perfusion and tissue regeneration.

### SUMMARY

The present disclosure is generally directed to a method of forming a resorbable biomaterial element for guiding bone regeneration in a defined zone as a basis for dental implants. The resorbable biomaterial element may be formed of collagen or bone graft. In one illustrative embodiment, the method involves forming a three-dimensional resorbable product contoured to a bone defect in a mandible or maxilla. The method steps include, providing a resorbable biomaterial element, such as a collagen element or bone graft solid element, texturing at least one surface of the element, wherein the texturing allows the element to be bent and formed into at least one desired and/or predetermined three-dimensional shape. In another method, the steps include determining a shape of the bone defect, selecting a collagen element or bone graft solid element with texturing on at least one surface of the collagen element or bone graft solid element and bending the collagen element or bone graft solid element to form a three-dimensional shape conforming to the shape of the bone defect.

In some embodiments, the collagen element is a sheet, and the texturing step includes forming a plurality of grooves in the collagen sheet in at least one direction, wherein the grooves are formed in at least one surface of the element and are formed to a depth sufficient to allow the sheet to be bent at the grooves. In one embodiment, the plurality of grooves are formed in two or more directions, where at least some of the grooves cross. A first set of substantially horizontal grooves may be formed crossing a second set of substantially vertical grooves, creating a grid pattern.

In other embodiments, a first set of grooves is formed in a first portion of the collagen sheet and a second set of grooves is formed in a second portion of the collagen sheet, and the first and second sets of grooves do not cross or intersect. The first set of grooves may be disposed in a first orientation and the second set of grooves may be disposed in a second orientation, where the first and second orientations are different, and the first portion of the sheet is bent in a first direction and the second portion of the sheet is bent in a second direction.

In still other embodiments, the texturing step may include forming a plurality of indentations in a top surface of the collagen sheet. The surface texturing may also be performed on a collagen element of non-uniform thickness.

The present disclosure is also directed to an implant for guiding bone regeneration for dental procedures. In some embodiments, the implant is a resorbable bone graft solid element in a block or other 3-D form, and the texturing step includes forming a plurality of grooves in the bone graft block in at least one direction, wherein the grooves are formed in at least one surface of the element and are formed to a depth sufficient to allow the sheet to be bent at the grooves.

The present disclosure is also directed to an implant for guiding bone regeneration for dental procedures. In some embodiments, the implant is a resorbable collagen matrix sheet having a plurality of surface contours formed in one or more surfaces of the sheet, the surface contours configured to allow bending of the sheet to conform to a shape of a bone defect in a mandible or maxilla. The plurality of surface contours may include a plurality of grooves extending in at least one direction, wherein the grooves are formed in at least one surface of the sheet and are formed to a depth sufficient to allow the sheet to be bent at the grooves. In some embodiments the grooves are formed such that a 0.3 mm minimum wall thickness is left in each groove. The collagen sheet may have a thickness ranging from about 0.5 mm to about 2.0 mm.

In some embodiments, the plurality of grooves are formed in two or more directions, where at least some of the grooves cross. In one embodiment, a first set of substantially horizontal grooves crosses a second set of substantially vertical grooves, creating a grid pattern. In another embodiment, a first set of grooves is formed in a first portion of the sheet and a second set of grooves is formed in a second portion of the sheet, where the first and second sets of grooves do not cross or intersect. The first set of grooves may be disposed in a first orientation and the second set of grooves may be disposed in a second orientation, the first and second orientations being different, allowing the first portion of the sheet to be bent in a first direction and the second portion of the sheet to be bent in a second direction.

In still other embodiments, the plurality of surface contours includes a plurality of pores through the collagen sheet or a plurality of indentations in a top surface of the collagen sheet.

### BRIEF DESCRIPTION OF THE DRAWINGS

The invention may be understood by reference to the following description taken in conjunction with the accompanying drawings, in which like reference numerals identify like elements.

FIG. 1 is an illustration of a mandible with a collagen sheet in place over a bone defect.

FIGS. 2A-2C are top views of collagen sheets showing various surface treatments.

FIG. 3 is a perspective view of a three-dimensional scored collagen or bone graft block.

FIGS. 4-7 are perspective views of a formed collagen sheet.

FIGS. 8-10 are perspective views of another embodiment of formed collagen sheet.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

The present invention will now be described with reference to the attached figures that are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

In general, in one aspect, the present disclosure is directed to various embodiments of a resorbable biomaterial interface or element for guiding bone regeneration to reconstruct or augment anatomical defects in preparation for various dental, oral, maxillofacial, and craniofacial procedures. Such procedures include the reconstruction or augmentation of a portion of the anterior and posterior maxilla or the anterior and posterior mandible, and in reconstruction of a palatal graft. In particular, the disclosure is directed to resorbable biomaterial elements designed for procedures involving dental implants. As will be readily apparent to those skilled in the art upon a complete reading of the present application, the resorbable biomaterial elements described herein may be used with a variety of different surgical procedures performed to install dental implants. Thus, neither the type of dental implant used nor the type of surgical procedure performed should be considered a limitation of the present invention. The resorbable nature of the resorbable biomaterial material reduces the trauma to the surgical site upon follow-up procedures when in preparation for placement of a dental implant. Examples of resorbable biomaterials are collagen and bone graft solids.

The resorbable biomaterial element is adapted to be securely positioned in a patient's jawbone (mandible or maxilla). The resorbable biomaterial element can be used in dental procedures to reconstruct or augment a portion of the anterior and posterior maxilla or mandible. It may also be used in reconstruction or a palatal graft, covering of a lateral window created during a Caldwell-Luc sinus lift procedure. An example of a dental procedure in which the formed resorbable biomaterial element may be used is a socket repair procedure with a 4-walled socket defect.

The resorbable biomaterial element is implanted in a non-hydrated state that maintains its semi-rigid construction. The element is cut to match the defect size and formed by hand to match the patient's anatomy. Surgical anchors are used to secure the element to the bone. The resorbable biomaterial element may take the form of a scaffold, sinus floor drape, ridge cover, socket liner, pallet shield, or bridge over a bony defect.

Resorbable biomaterial may be provided as a sheet or a three-dimensional form. Surface texturing is performed on the resorbable biomaterial sheet or element to create unique surface features designed to give versatility to the mechanical properties of the material. The resorbable biomaterial sheet or three-dimensional form may be scored to create grooves or channels. The grooves or channels may create a surface feature of ribs and valleys forming a grid along an otherwise flat surface. The ribs provide sheet strength and thickness, while still maintaining some flexibility through the thinner areas. Textures such as micro-grooves may be formed for channeling of fluid flow. Another surface texture is made up of tiny protruding hooked spines, simulating Velcro®. This type of surface texture would provide initial fixation of a resorbable biomaterial sheet to the host tissue. Micro-pores or holes may also be formed in the resorbable biomaterial sheet to preclude some cells while allowing the diffusion or infiltration of other cells. This has the benefit of increasing the potential for vascular ingrowth and perfusion by exposing the graft material to the natural healing environment.

The grooves or channels may extend in multiple directions to provide flexibility in multiple directions allowing the sheet to be contoured to the patient's anatomy and bone defect. The grooves or channels may be formed parallel or perpendicular to each other, in a converging or diverging orientation, or any other pattern that provides flexibility to the sheet or three-dimensional form. The grooves or channels may be formed on one side of the sheet. In other embodiments, grooves or channels are scored into both sides of a resorbable biomaterial sheet. Scoring on both sides provides increased flexibility and allows the sheet to be formed into at least one desired and/or predetermined three-dimensional shape.

Various combinations of surface texturing may be used to achieve a particular function. Examples of functions provided by surface texturing include, but are not limited to, controlled permeability, targeted flexibility, localized porosity, increased strength, added fixation, guided release of therapeutic agents, and cell occlusion. The various surface texturing effects can be created through the use of laser technology, similar to laser etching, 3-D printing, engraving, stamping, molding, or sintering technologies.

An alternative to adding surface textures to a resorbable biomaterial sheet or element is utilizing a mesh, sponge or other porous form of resorbable biomaterial which has a repeated or random pattern on the surface. Increasing the porosity of the material or decreasing the density may provide an alternative to the surface texturing.

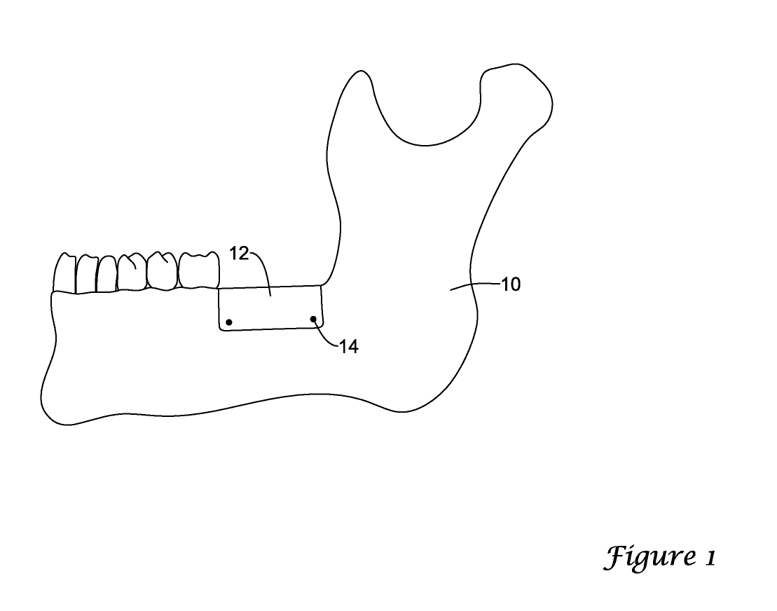

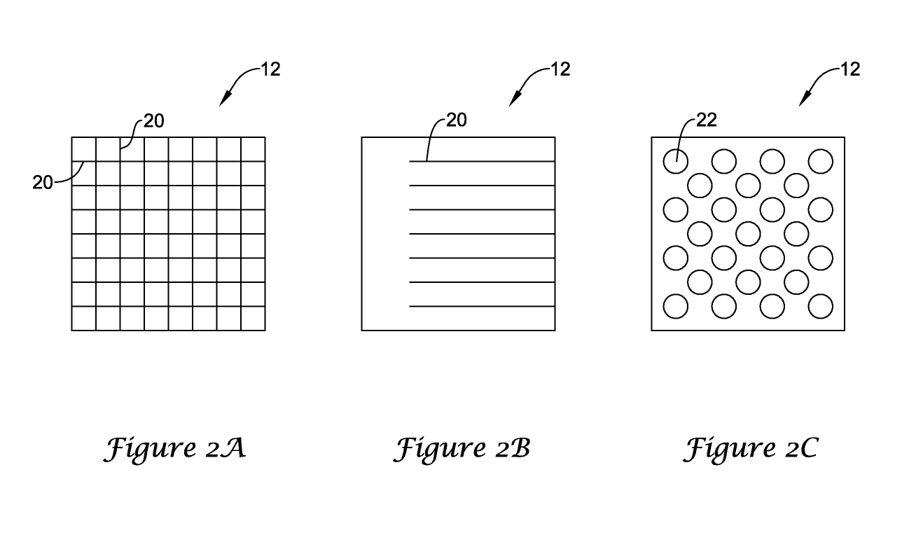

FIG. 1 shows a mandible 10 with a collagen sheet 12 in place over a bone defect. The collagen sheet may be fastened to the bone with one or more fasteners 14. FIGS. 2A-2C show collagen sheets with various surface treatments. FIG. 2A illustrates a collagen sheet 12 with a series of horizontal and vertical grooves 20 forming a grid pattern. FIG. 2B shows a collagen sheet 12 with a series of horizontal grooves 20 extending part way across the sheet. FIG. 2C shows a collagen sheet 12 with a plurality of pores 22 arranged in a pattern.

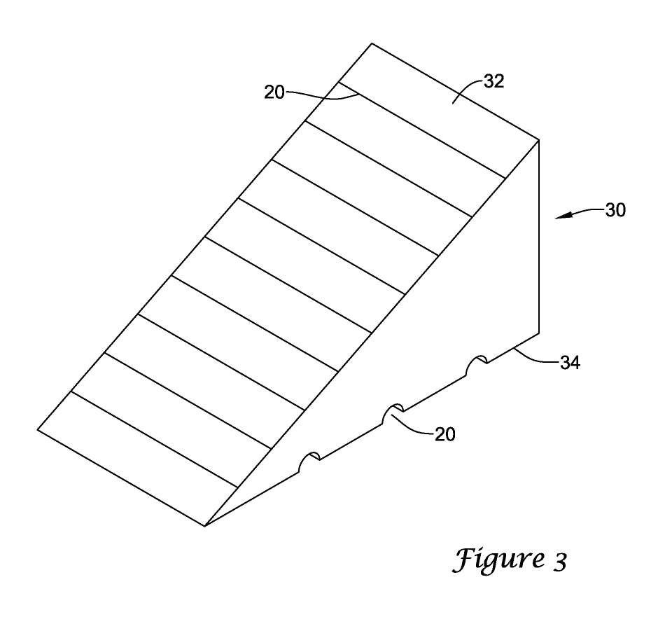

The resorbable biomaterial may be in a three-dimensional form such as a block or wedge. FIG. 3 shows a collagen block 30. The three-dimensional form may be scored 20 or have cut-outs or other surface treatments that allow the block or wedge to be formed into another shape to conform to a specific bone defect. In the embodiment illustrated in FIG. 3, the block 30 has a plurality of score lines 20 in an upper surface 32 and a lower surface 34.

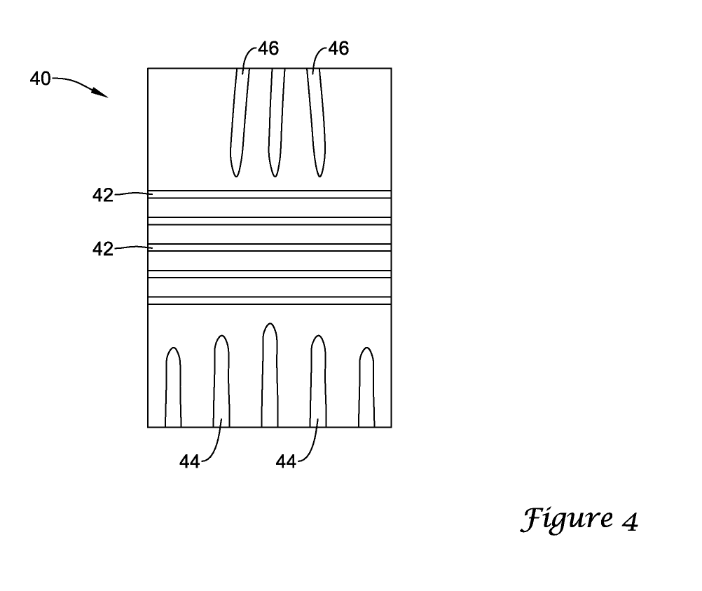

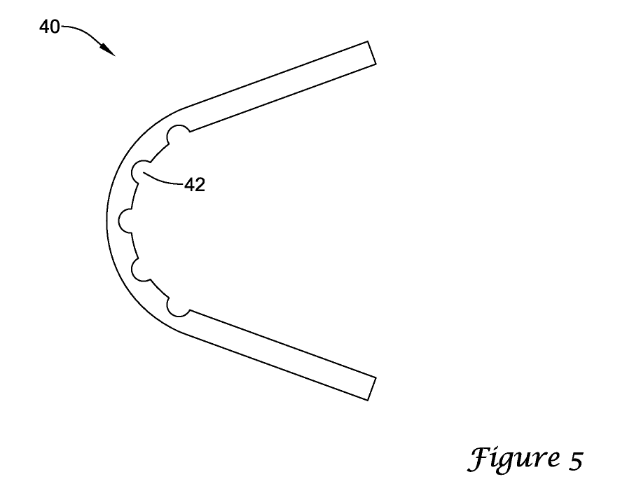

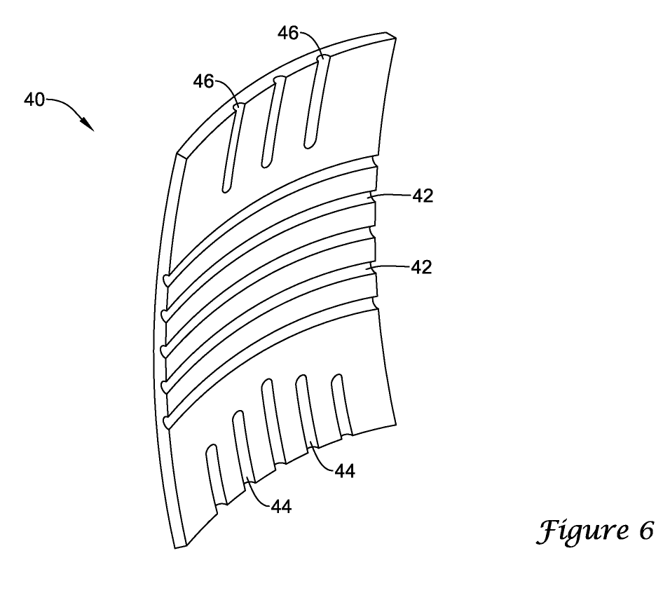

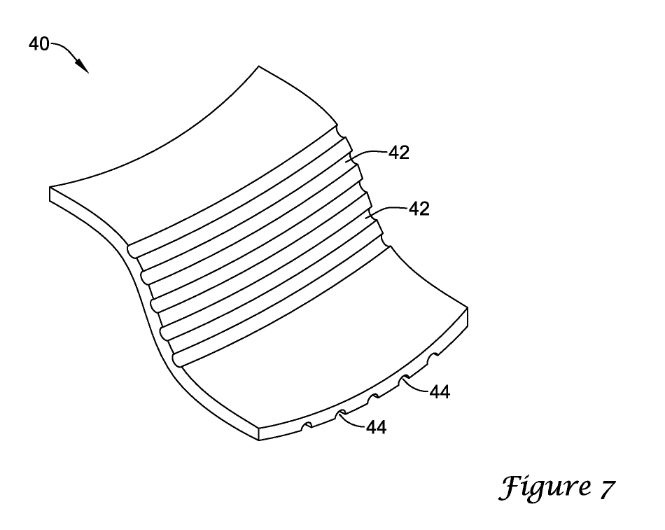

An embodiment of collagen sheet 40 with grooves 42, 44, 46 arranged to allow the sheet 40 to be formed into a three-dimensional shape that confirms to the anterior maxilla is shown in FIGS. 4-7. The sheet 40 is scored with horizontal grooves 42 across a center portion and vertical grooves 46, 44 extending along upper and lower regions, respectively. This pattern of grooves allows the sheet to be bent and formed, as shown in FIGS. 5 and 6. The sheet may be bent to conform to the anterior maxilla. In some embodiments, the horizontal grooves are in an upper surface and the vertical grooves are in a lower surface, as shown in FIG. 7.

The grooves or channels provide flexibility without compromising surface coverage and exposing the graft material to movement and contact with surrounding soft tissue.

The collagen sheet 40 illustrated in FIGS. 4-7 has grooves 42, 44, 46 in various orientations that allow the sheet to be formed into a three-dimensional shape conforming to a specific bone defect. As seen in FIGS. 4-7, the collagen sheet 40 has substantially horizontal 42 and vertical 44 grooves which allow the sheet to be bent into a variety of curved shapes. In some embodiments, grooves 42, 44, 46 are only formed on one side of the collagen sheet 40, as shown in FIG. 6. In other embodiments, some grooves are formed on one side of the sheet and other grooves are formed on the opposite side of the sheet, as shown in FIG. 7. The grooves may be formed in any combination of direction and side of the sheet to achieve a desired three dimensional form. As seen in FIG. 5, the grooves 42 extend part way through the thickness of the sheet. In one embodiment, a 0.5 mm minimum wall thickness is left in each groove. In some embodiments, the sheet 40 has a thickness of about 0.7 mm to 2.0 mm. The grooves 42 allow the sheet to be curved, creating a depth of about 15.0±1.5 mm from an end of the sheet to a highest point on the curve. The un-bent, flat sheet may have a width between about 10 mm to 35 mm, and a length of about 35 mm to 45 mm.

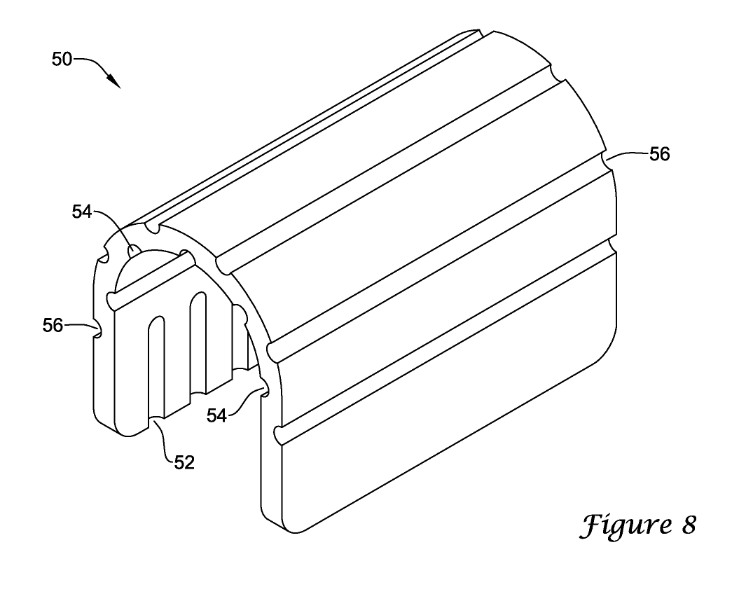

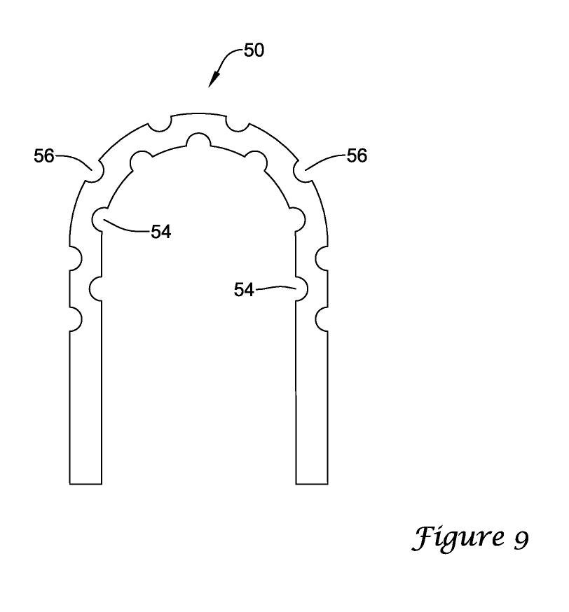

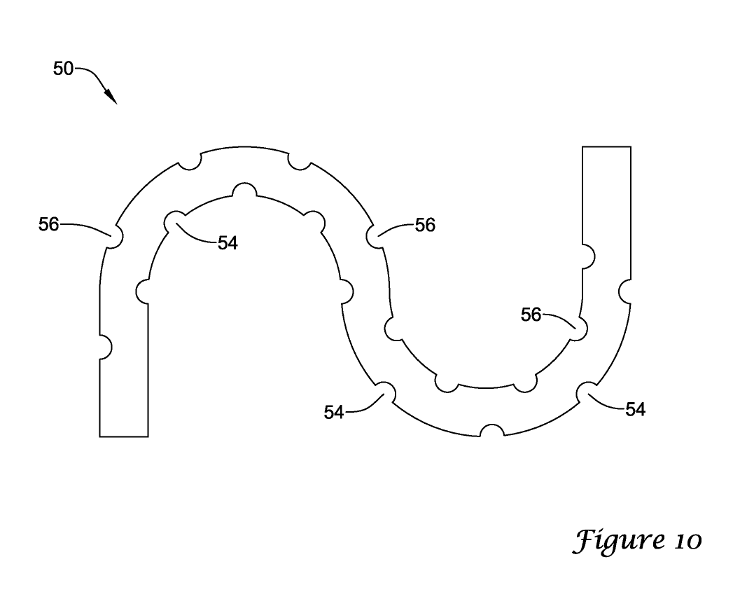

Another embodiment of formed collagen sheet 50, shown in FIGS. 8 and 9, is grooved and can be shaped to fit the posterior mandible. In this embodiment a plurality of substantially horizontal grooves 54 allows for folding the sheet into a U shape as shown in FIGS. 8 and 9. In some embodiments sheet is folded in an offset manner such that one leg is longer than the other. A series of substantially vertical grooves 52 allow for folding the sheet in a different direction. The grooves 54 and 56 are cut into opposite sides of the sheet and allow the sheet to be bent in opposite directions, such as the serpentine shape shown in FIG. 10. The grooves 52, 54 can be cut into the sheet to a depth leaving a minimum 0.5 mm wall thickness in the groove 52, 54. The sheet 50 can have a thickness of about 0.7 mm to 2.0 mm, a height of about 15 mm to 25 mm, and a width of about 30 mm to 40 mm. In some embodiments, the distance between the ends when the sheet is folded is about 5 mm to 7 mm.

Another surface treatment of the collagen sheet that allows for forming the sheet into a three-dimensional shape to conform to a bone defect is perforation. The collagen sheet 12 is perforated to create pores 22 which increases the vascular ingrowth and perfusion through the sheet. See FIG. 2C. The perforation can be a consistent or varying size, and may be in a consistent or varying pattern. The perforation can be in the form of pores or holes through the sheet. In other embodiments, the perforation is in the form of slits or non-uniform shaped voids. In still other embodiments, the perforation is a series of indentations or depressions that do not extend through the sheet. As with the grooves, indentations or depressions may be in only one side of the sheet or in both sides. The indentations or depressions may be in any shape and arrangement. The perforation allows for forming the sheet into at least one desired and/or predetermined three-dimensional shape to conform to a patient's anatomy. The sheet may have additional regions of reduced density including scored or formed grooves or channels to further increase the flexibility of the sheet. In another embodiment, grooves, channels, depressions, or holes are formed in a molded collagen sheet during the molding process.

The collagen is resorbable and provides a structure to guide bone regeneration in a defined zone or region based on its semi-rigid shape. The resorbable nature of the collagen material reduces the trauma to the surgical site upon follow-up procedures when in preparation for placement of a dental implant. In another embodiment, a block form bone graft is covered by a collagen sheet that is scored and formed to contour to the bone defect.

Those skilled in the art will recognize that the present invention may be manifested in a variety of forms other than the specific embodiments described and contemplated herein. Accordingly, departure in form and detail may be made without departing from the scope and spirit of the present invention as described in the appended claims.

What is claimed is:

1. A method of forming a three-dimensional resorbable product contoured to a bone defect in a mandible or maxilla, comprising:
providing a resorbable biomaterial element;
texturing at least one surface of the biomaterial element, wherein the texturing allows the biomaterial element to be bent and formed into at least one three-dimensional shape;
bending the biomaterial element to form a three-dimensional shape conforming to a shape of the bone defect.

2. The method of claim 1, wherein the resorbable biomaterial element is a collagen sheet or an allograft bone block.

3. The method of claim 2, wherein the biomaterial element is a collagen sheet and wherein the texturing step includes forming a plurality of grooves in the collagen sheet in at least one direction, wherein the grooves are formed in at least one surface of the sheet and are formed to a depth sufficient to allow the sheet to be bent at the grooves.

4. The method of claim 3, wherein the plurality of grooves are formed in two or more directions, where at least some of the grooves cross other grooves.

5. The method of claim 4, wherein a first set of substantially horizontal grooves cross a second set of substantially vertical grooves, creating a grid pattern.

6. The method of claim 3, wherein the texturing step includes forming a first set of grooves in a first portion of the sheet and forming a second set of grooves in a second portion of the sheet, where the first and second sets of grooves do not cross or intersect.

7. The method of claim 6, wherein the first set of grooves are disposed in a first orientation and the second set of grooves are disposed in a second orientation, the first and second orientations being different, wherein the bending step includes bending the first portion of the sheet in a first direction and bending the second portion of the sheet in a second direction.

8. The method of claim 2, wherein the biomaterial element is a collagen sheet and wherein the texturing step includes forming a plurality of pores through the collagen sheet.

9. The method of claim 2, wherein the biomaterial element is a collagen sheet and wherein the texturing step includes forming a plurality of indentations in a top surface of the collagen sheet.

10. The method of claim 1, wherein the resorbable biomaterial element is a collagen wedge.

11. An implant for guiding bone regeneration for dental procedures, the implant comprising a resorbable collagen matrix sheet having a plurality of surface contours formed in one or more surfaces of the sheet, the surface contours configured to allow bending of the sheet into at least one three-dimensional shape conforming with a bone defect in a mandible or maxilla.

12. The implant of claim 11, wherein the plurality of surface contours includes a plurality of grooves extending in at least one direction, wherein the grooves are formed in at least one surface of the sheet and are formed to a depth sufficient to allow the sheet to be bent at the grooves.

13. The implant of claim 12, wherein the grooves are formed such that a 0.5 mm minimum wall thickness is left in each groove.

14. The implant of claim 12, wherein the plurality of grooves are formed in two or more directions, where at least some of the grooves cross other grooves.

15. The implant of claim 14, wherein a first set of substantially horizontal grooves crosses a second set of substantially vertical grooves, creating a grid pattern.

16. The implant of claim 12, wherein a first set of grooves is formed in a first portion of the sheet and a second set of grooves is formed in a second portion of the sheet, where the first and second sets of grooves do not cross or intersect.

17. The implant of claim 16, wherein the first set of grooves are disposed in a first orientation and the second set of grooves are disposed in a second orientation, the first and second orientations being different, allowing the first portion of the sheet to be bent in a first direction and the second portion of the sheet to be bent in a second direction.

18. The implant of claim 11, wherein the plurality of surface contours includes a plurality of pores through the collagen sheet.

19. The implant of claim 11, wherein the plurality of surface contours includes a plurality of indentations in a top surface of the collagen sheet.

20. The implant of claim 13, wherein the collagen sheet has a thickness ranging from about 0.7 mm to about 2.0 mm.
